(19) United States
(12) Patent Application Publication
(10) Pub. No.: US 2016/0133239 A1
(43) Pub. Date: May 12, 2016

(54) INSTRUMENT CARRYING CASE

(71) Applicant: Eric Hook, Ann Arbor, MI (US)

(72) Inventor: Eric Hook, Ann Arbor, MI (US)

(21) Appl. No.: 14/933,645

(22) Filed: Nov. 5, 2015

Related U.S. Application Data
(60) Provisional application No. 62/076,056, filed on Nov. 6, 2014.

(51) Int. Cl. G10G 7/00; A45F 3/04

(52) U.S. Cl. CPC G10G 7/005; A45F 3/047

(57) ABSTRACT

A case system for transporting a musical instrument has a ridged case and an associated non-ridged component disposed about the ridged component. The non-ridged component is formed from a non-rigid material such a fabric. A first body portion, a second body portion, and plurality of straps of the non-rigid component collectively define a cavity within the non-ridged component to hold the ridged case. The non-ridged component is formed from a non-rigid material such a fabric. A first body portion, a second body portion, and plurality of straps of the non-rigid component collectively define a cavity within the non-ridged component to hold the ridged case. The area between the first and second body portions defines a vertical gap and a horizontal gap that collectively surround at least a portion of the ridged case.

### CROSS-REFERENCE TO RELATED APPLICATIONS

This application claims the benefit of U.S. Provisional Application No. 62/076,056, filed on Nov. 6, 2014. The entire disclosure of the above application is incorporated herein by reference.

### FIELD

The present disclosure relates broadly to a carrying case for a musical instrument. More particularly, the disclosure relates to a musical instrument carrying case that has a ridged carrying case and a non-rigid support structure.

### BACKGROUND

Professional and amateur players of guitar, banjo, violin, or other stringed instruments are extremely protective of their instruments, which are typically delicate and expensive devices. Damage to a stringed instrument often affects both the looks and the musical quality of the instrument (including the sound of the instrument and monetary value). Thus, professional and amateur players typically must take great care of their instruments, especially during transport or when the player is not using the instrument.

Typically, a stringed instrument is transported in a rigid or hard shell case for protection. These rigid or hard shell cases have handles for the player to carry the instrument much like a suitcase, which is typically not a comfortable means for manually carrying the instrument.

Non-rigid or ridged bags or cases are commercially available and often equipped with straps for the player to comfortably carry the instrument on his or her back. However, non-rigid bags or cases alone typically do not offer both the protection that a rigid or hard shell case provides at times that a player has to take extra care in setting down the non-rigid bag or case containing the instrument on the floor, against a wall.

Therefore, a need exists for a carrying case for a musical instrument that overcomes the problems noted above and others previously experienced with cases having a rigid frame or hard shell case as well as non-ridged case.

### SUMMARY

This section provides a general summary of the disclosure, and is not a comprehensive disclosure of its full scope or all of its features.

In accordance with apparatus consistent with the present disclosure, a musical instrument carrying case system is provided that overcomes the problems noted herein with conventional carrying cases. The case system has a ridged component and an associated non-ridged component disposed about the ridged component. The ridged case has a bottom side, a top side, a backside, and a front side that collectively define a cavity within the ridged case to hold a musical instrument, such as a guitar or violin. The non-ridged component is formed from a non-rigid material such a fabric. The non-ridged component has a first body portion, a second body portion, and plurality of straps of the non-rigid component collectively defines a first cavity within the non-ridged component to hold the ridged case. The first and second body portions can both additionally define cavities which can be used to store music, a music stand or books. The area between the first and second body portions defines a vertical gap and a horizontal gap that collectively surround at least a portion of the ridged case. Optionally, a portion of the ridged case at least partially protrudes from the vertical gap. Across the horizontal or lower gap is a plurality of adjustable straps that are fastened to both the first and second body portions and functions to support the weight of the ridged case and instrument. The plurality of adjustable straps is pivotally attached across the vertical gaps to allow selective engagement with the ridged case.

In one implementation, the second predetermined distance is set such that when the releasable strap is in the second position, the releasable strap maintains the backside of the non-rigid component taut below the point where the first end of the releasable strap is pivotally attached to the backside of the non-ridged component and the compartment remains in an open position when the musical instrument is removed.

In another embodiment, a musical instrument carrying case structure is provided having a ridged case with a concave side, a bottom side, a top side, a backside, and a front side that collectively define a first internal cavity configured to accommodate and enclose a musical instrument. A non-rigid support structure, defining a second internal cavity and having a first body portion in contact with the backside of the ridged case and second body portions in contact with the backside of the ridged case. The second body portion defined a pocket. The first and second body portions define a vertical gap and a horizontal gap there between and having a plurality of straps selectively attachable between the first and second body portions at least one strap being disposed within a depression formed by the concave side of the ridged case.

A pair of shoulder straps may also be attached between a backside of the non-ridged component and a pair of releasable couplings or fasteners. When the releasable strap is in the first position the strap causes the releasable strap, the first member, and the second member to be co-planar.

In accordance with apparatus consistent with the present teachings, another embodiment of a musical instrument ridged carrying case and non-rigid support structure is provided. The non-ridged component has a bottom side, a top side, a backside, and a front side that collectively define an internal cavity configured to accommodate and enclose a ridged case. The non-ridged component is formed of a non-rigid material. A first member and a second member are each affixed to the backside of the non-ridged component. A releasable strap, having a first end and a second end, is pivotally attached to the first and second members at a first predetermined distance from the bottom of the non-ridged component such that the releasable strap pivots between a first position, in which the releasable strap is substantially parallel with the back of the case, and a second position, in which the second end of the releasable strap is at least a second predetermined distance away from the bottom of the case such that releasable strap sufficiently supports the case when the musical instrument is removed from the case.

In one implementation, the non-ridged component defines a vertical gap and a horizontal gap that collectively define a first cavity. A strap is disposed across the horizontal gap is at the first predetermined distance from the bottom of the non-ridged component so as to define a support for the ridged case. The vertical gap may effectively intersect the horizontal gap where a pair of side straps defines a first support and a second side supports. Each support can be formed of a pair of straps. Additionally, there may be a first fastening element having a first part and a second part associated with the first support pair of straps and a second side supports pair of straps.

In another related embodiment, the first part may be attached to the first of a pair of straps and the second part may be attached to the second of the pair of straps. The first part may be adapted to selectively engage the second part to vertically fasten the first strap to the second strap. There may also be a second fastening element having a third part attached to the second support, a fourth part attached to the second support, and a fifth part attached to the front panel. The third part may be adapted to selectively engage a portion of the fifth part to horizontally fasten the first support to the front panel and the fourth part may be adapted to selectively engage a remainder of the fifth part to horizontally fasten the second support to the front panel.

According to another teaching, a musical instrument carrying case structure is provided having a ridged case with a first and second opposed sides, a bottom side, a top side, a back side, and a front side that collectively define a first internal cavity configured to accommodate and enclose a musical instrument. The carrying case structure has a non-rigid support structure, defining a first body portion in contact with the back side of the ridged case and second body portion in contact with the front side of the ridged case, the second body portion defining a pocket, the first and second body portion defining a vertical gap disposed adjacent the first and second opposed sides and a horizontal gap disposed adjacent the bottom side. A first support strap is disposed between the first and second body portions and adjacent the bottom side. Second and third support straps are disposed between the first and second body portions and adjacent the first and second opposed sides a plurality of straps between the first and second body portions.

Other systems, methods, features, and advantages of the present disclosure will be or will become apparent to one with skill in the art upon examination of the following figures and detailed description. It is intended that all such additional systems, methods, features, and advantages be included within this description, be within the scope of the disclosure, and be protected by the accompanying claims.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1-5 represent an instrument carrying system according to the present invention;

FIGS. 6-14 represent views of an alternate instrument carrying system;

FIGS. 15-20 depict a carrying strap system according to the present teachings;

FIG. 21 represents a music holder associated with the instrument carrier of the present teachings;

FIGS. 22-24 represents a music stand holder associated with the instrument carrier of the present teachings;

FIG. 25 represents carrying straps for the instrument carrying system according to the present invention in a closed configuration;

FIGS. 26-31 depict the instrument carrying system according to an alternate teaching of present invention in an open configuration.

Corresponding reference numerals indicate corresponding parts throughout the several views of the drawings.

### DETAILED DESCRIPTION

Example embodiments will now be described more fully with reference to the accompanying drawings.

Reference will now be made in detail to implementations in accordance with products consistent with the present disclosure as illustrated in the accompanying drawings.

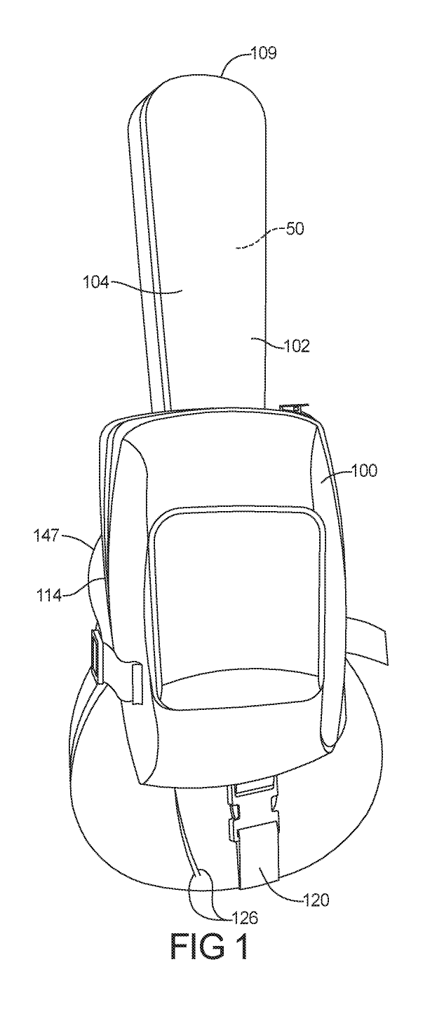

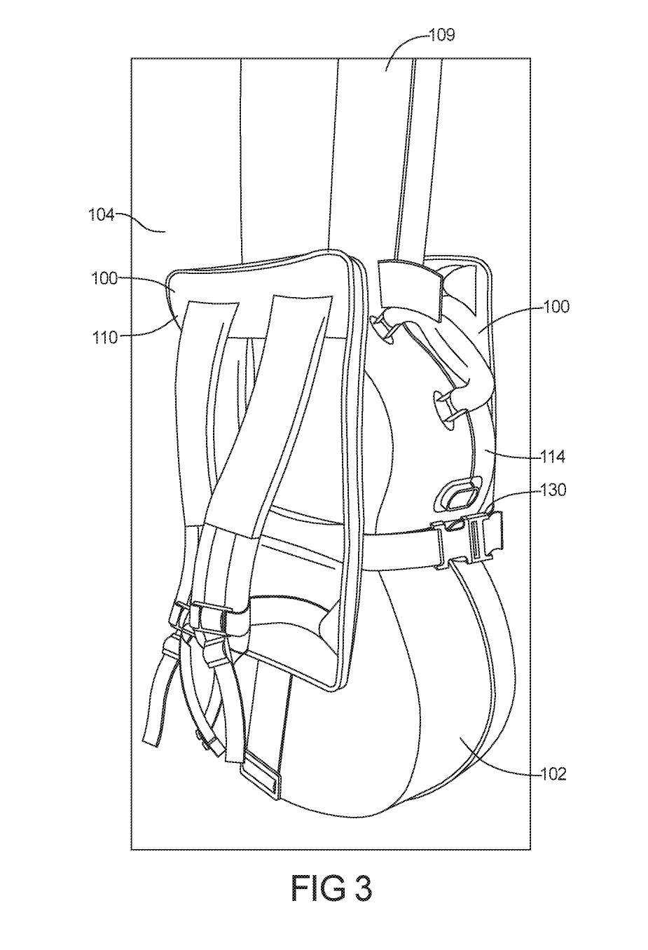

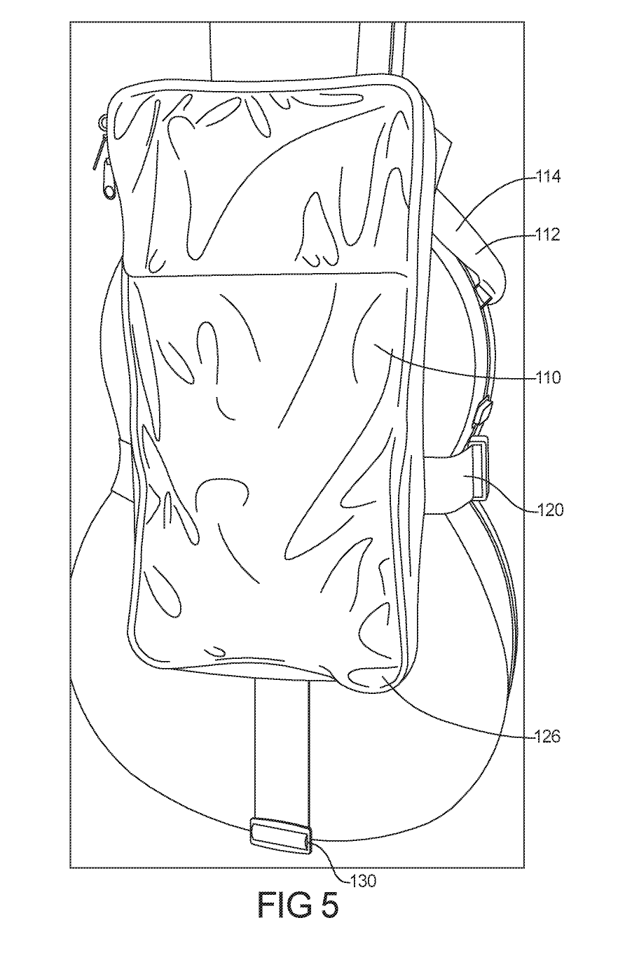

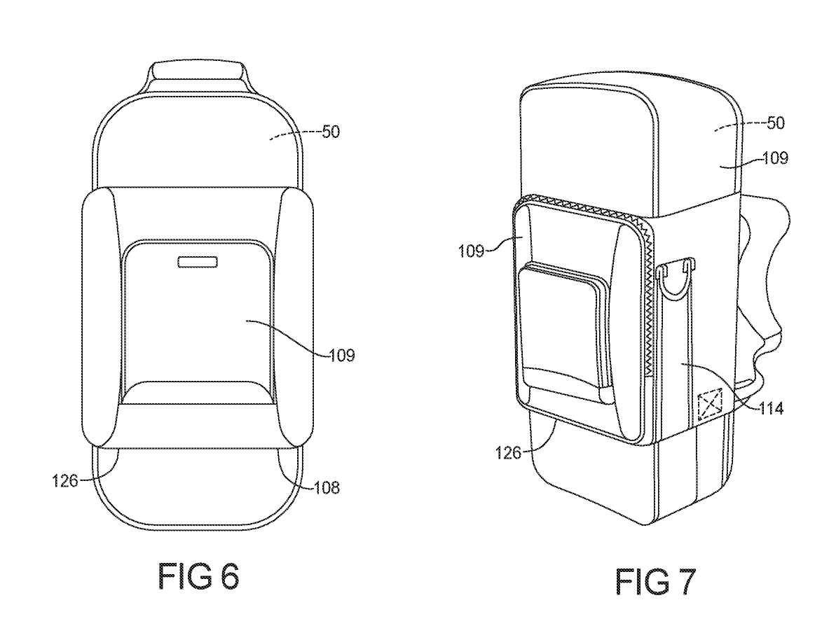

FIGS. 1-6 depict one exemplary ridged musical instrument carrying case 101 and non-rigid support structure 100 consistent with the present disclosure (also referenced as “carrying case and non-rigid support structure 100”). The FIGS. depict front views of the musical instrument carrying case and non-rigid support structure 100 in which the musical instrument (referenced as “50”) is enclosed within the ridged case 102 and made accessible in accordance with the present disclosure as described herein. A rear view of the musical instrument carrying case and non-rigid support structure 100 showing the non-rigid support structure 100 in a case supporting position consistent with the present disclosure where the musical instrument 50 is enclosed within the case 102.

FIGS. 1-3 depict a front and side view of the musical instrument carrying case and non-rigid support structure 100 showing a pocket 113 in the case 102 for holding the musical instrument 50, such as a guitar, upright in cooperation with the non-rigid support structure 100 in accordance with the present disclosure when the instrument 50 is not being used.

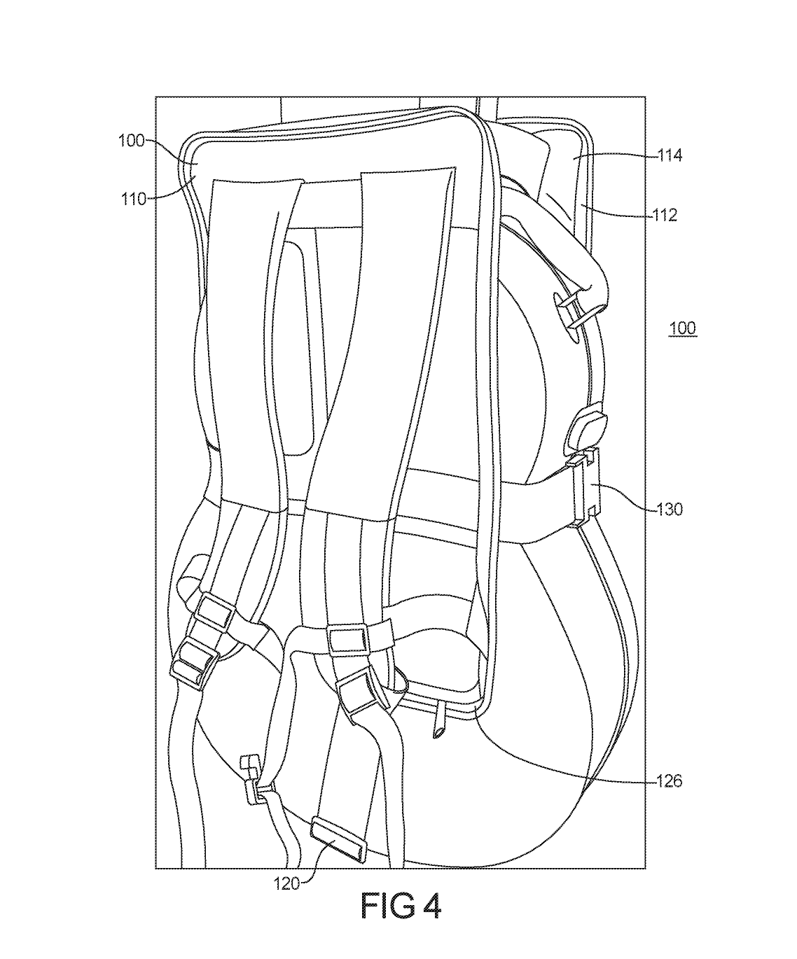

FIGS. 4 and 5 depict a rear view of the musical instrument carrying case and non-rigid support structure 100 showing the non-rigid support structure 100 in a carrying position for a user to comfortably transport the carrying case and non-rigid support structure 100. Optionally, the first portion discloses a pair of shoulder straps 152 which are each fixably coupled to the first portion. At a second end, the shoulder straps 152 are selectively attachable to the first portion to allow for adjustment of the shoulder straps 152. Also shown is the side strap adjacent a convex surface to engage and support a concave surface.

Thus, without the present disclosure, a user desiring to remove a musical instrument from a case or display the musical instrument in the case would have to open the entirety of the case to do so, exposing the musical instrument to potential damage. Additionally, with the case 102 supported by the non-rigid support structure 100, a user may more easily remove the musical instrument 50 from the case 102 by laying the case 102 on the ground or table to do so.

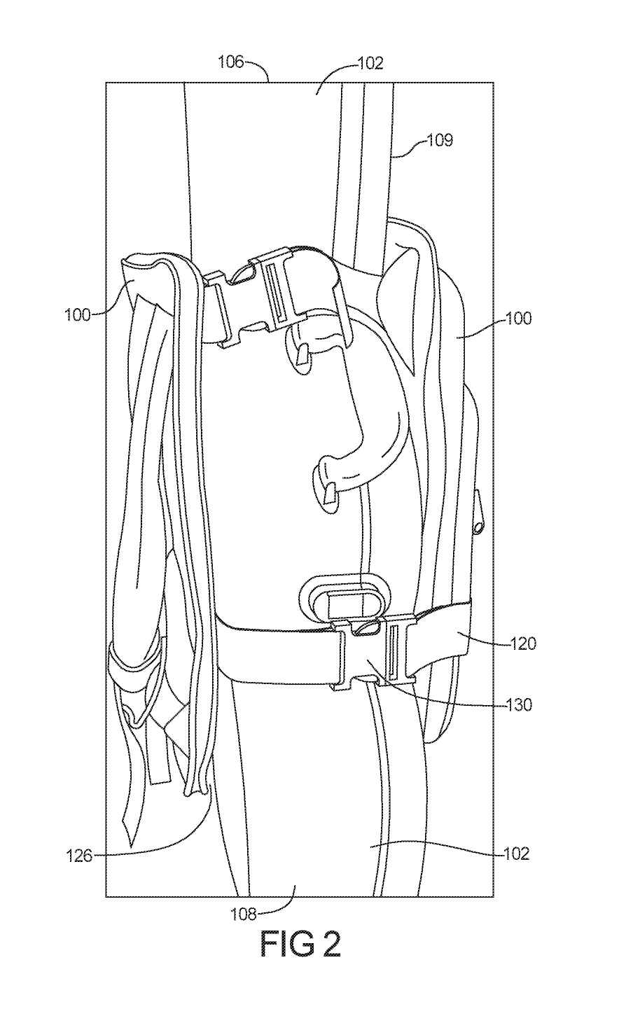

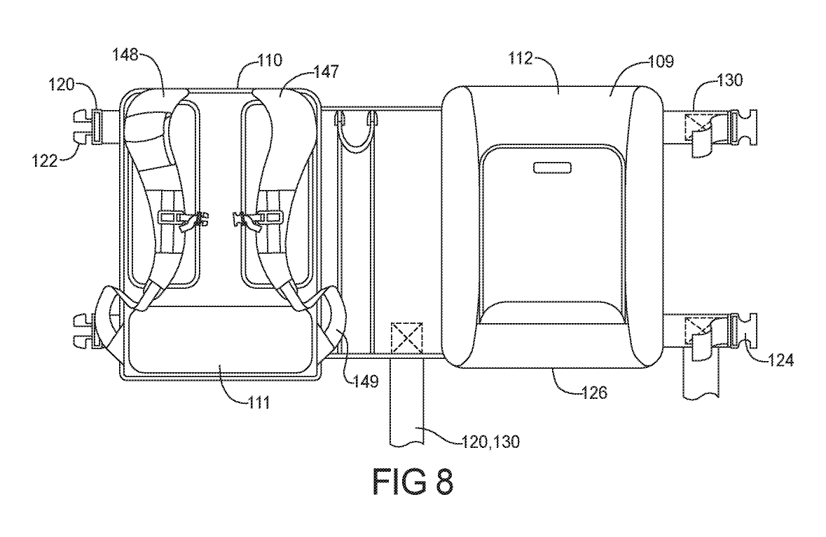

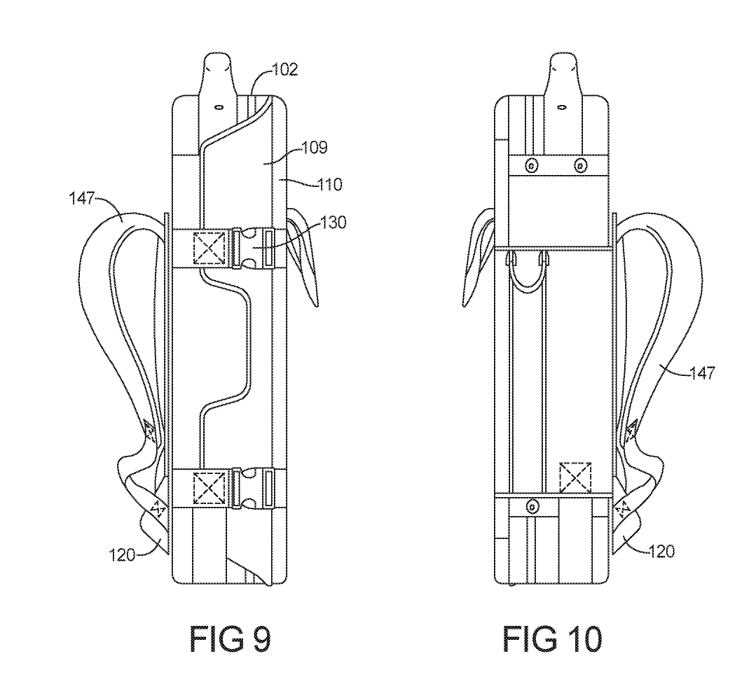

The FIGS. 2-4 and 8-13 depict the rear view of the musical instrument carrying case and non-rigid support structure 100 consistent with the present disclosure. The non-rigid support structure 100 is attached to the backside 105 and front side of the ridged case 102. The non-rigid support structure 100 includes air permeable padded shoulder straps 147 having a first end 148 and a second end 149. The first end 148 is pivotally attached to the backside 105 of the case 102. Optionally, the shoulder straps can be enclosed within a zippered flap 111 which can be stored in a pocket.

The ridged carrying case 102 and non-rigid support structure 100 has a front side 104, a backside 105, a top side 106, and a bottom side 108. The sides 104, 105, 106, and 108 of the ridged case 102 collectively define an internal cavity that accommodates a musical instrument 50. The non-rigid support structure is formed of a first body portion 112 and a second body portion 114 which defines an internal cavity which supports and surrounds the ridged case 102. The non-rigid support structure first body portion 112 and second body portions 114 can each define internal cavities is the pocket 113. The internal cavities or pockets 113 formed in the first body portion 112 and second body portions 114 may be accessed via front panel body portions 110 and 112 as further discussed herein.

The carrying case and non-rigid support structure 100 is illustrated for carrying and supporting guitars as the musical instrument 50. However, one of ordinary skill in the art, having reviewed the present application, will appreciate that the carrying case and non-rigid support structure 100 may be employed for carrying other musical instruments, e.g., banjos, violins, saxophones, cellos, or trombones.

The non-ridged component 100 is made from a sufficient non-rigid material that may include leather, cloth, nylon, or other non-rigid materials that lack support to keep the ridged case 102 in an upright or non-rigid support structuring position without a rigid skeletal structure or external frame. Thus, without the present disclosure, the non-rigid case would collapse to the floor when a musical instrument and ridged case is removed from the case non-rigid case.

The front side 104 of the non-ridged component 103 has a vertical gap 114 and horizontal gap 126 that collectively define a front panel 109 and a first body portion 110. The vertical gap 114 and horizontal gap 126 are maintained by fastening elements such as by straps or (i.e. fastening elements 120 and 130) the straps 120 and 130 are shown fastened to reflect the vertical gap 114 and the horizontal gap 126 that provide access to the internal cavity of the carrying case and non-rigid support structure 100, so that the musical instrument 50 ridged case may be removed from or replaced therein while the non-rigid support structure 100 is in the supporting position as described herein. The horizontal gap 126 is disposed at a first predetermined distance (d1) from the bottom side 108 of the non-ridged component 103 to define a pocket 113 within the non-ridged component 103 at a lower portion of the internal cavity.

When the vertical gap 114 and the horizontal gap 126 are in a second or engaged position, the musical instrument 50 is enclosed and retained within the ridged case 102. When the vertical gap 114 and the horizontal gap 126 are opened, the musical instrument 50 can be removed from or replaced in the ridged case 102.

In one implementation, the vertical gap 114 effectively intersects the horizontal gap 126 to define a first body portion 110 and a second body portion 112. When the vertical gap 114 and the horizontal gap 126 are opened, the first body portion 110 and the second body portion 112 can be folded down to expose the ridged case 102 and musical instrument 50 within. The musical instrument 50 and ridged case 102 can then be easily removed from the pocket 113 within the non-ridged portion 100 for the user to play. Additionally, with the first body portion 110 and the second body portion 112 folded down, the user can also display the musical instrument 50 while it is in the rigid case 102 and supported by the non-rigid support structure 100 in accordance with the present disclosure. This is particularly useful when a user is performing and needs to swap instruments or to take a break between songs or before or after a show.

The vertical gap 114 and the horizontal gap 126 may have fastening elements 120 and 130 or straps too partially or completely close both gaps 114 and 126. In this implementation, the first fastening element 120 may be comprised of a first part 122 attached to the first body portion 110 on the front side 104 of the case 102, and a second part 124 attached to the second body portion 112 on the front side 104 of the case 102, where the first and second parts 122 and 124 may be selectively engaged to close the vertical gap 114. When the first part 122 and the second part 124 are engaged or fastened, the musical instrument 50 is more securely retained within the case 102.

In the implementation shown in the FIGS. 8-14, the first fastening element 120 can be a plurality of straps. In this implementation, the first part 122 and the second part 124 are the complementary teeth for the zipper. However, the first and second parts 122 and 124 of the first fastening element 120 may be formed from complementary hook and loop fasteners (or Velcro parts), buttons and corresponding button holes, complementary snap fasteners, or other fastening elements that can be engaged or disengaged by the user to allow access into the internal cavity of the case 102. Additionally one strap can be fixably coupled to the first and second body portions and can have width much larger than the other. In this regard, the second strap can represent a cloth panel which runs between the top and bottom the first and second body portions.

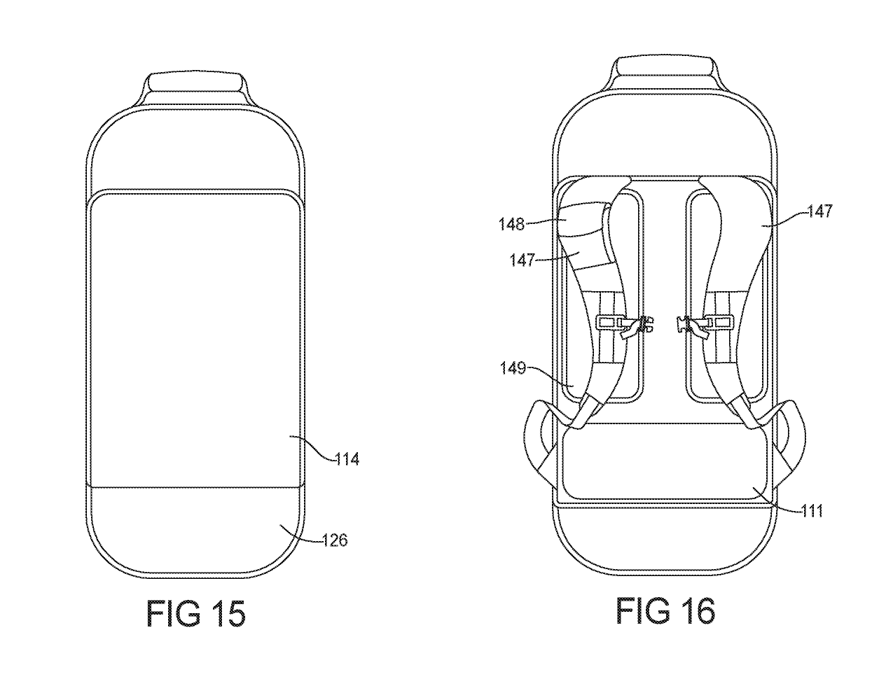

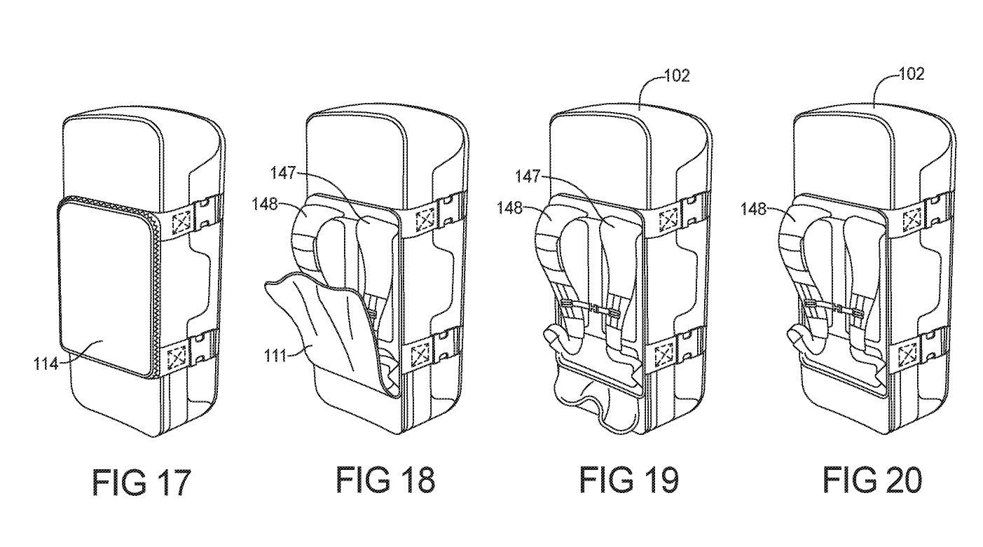

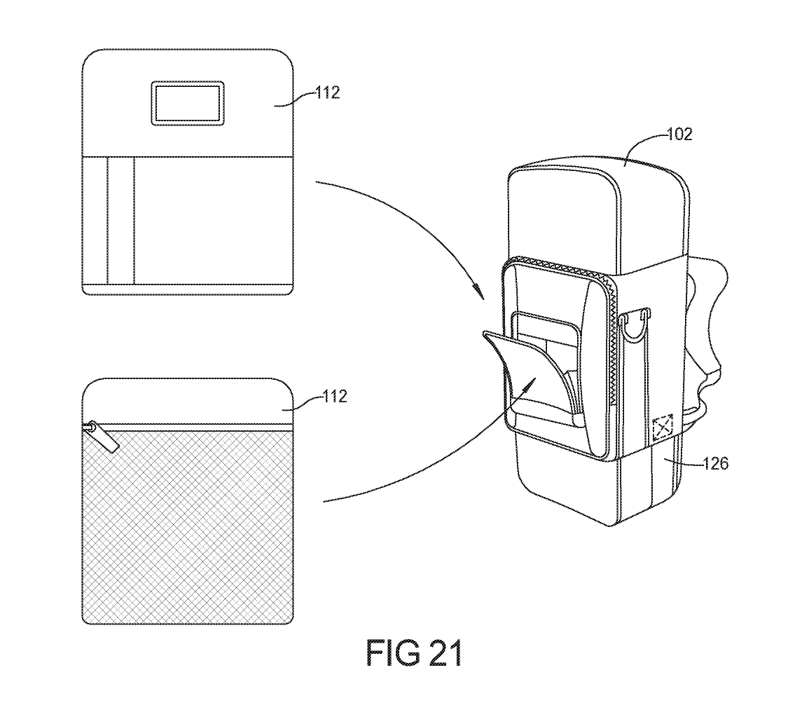

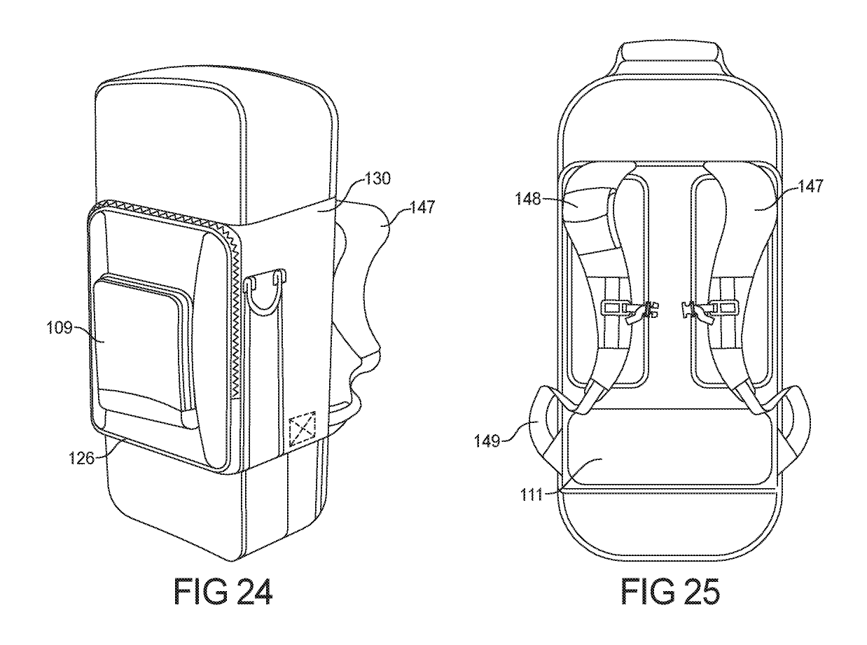

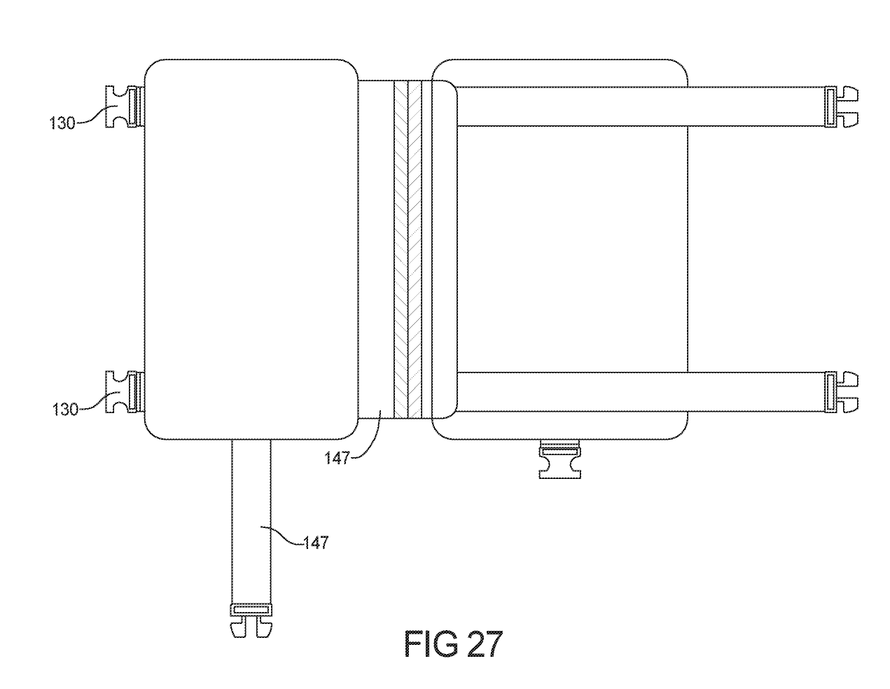

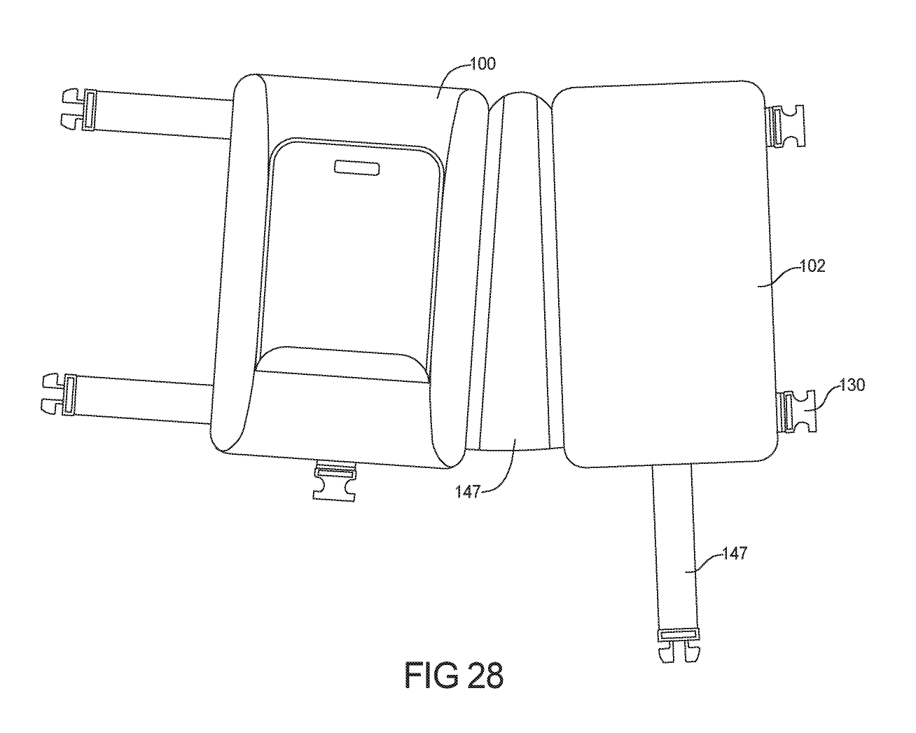

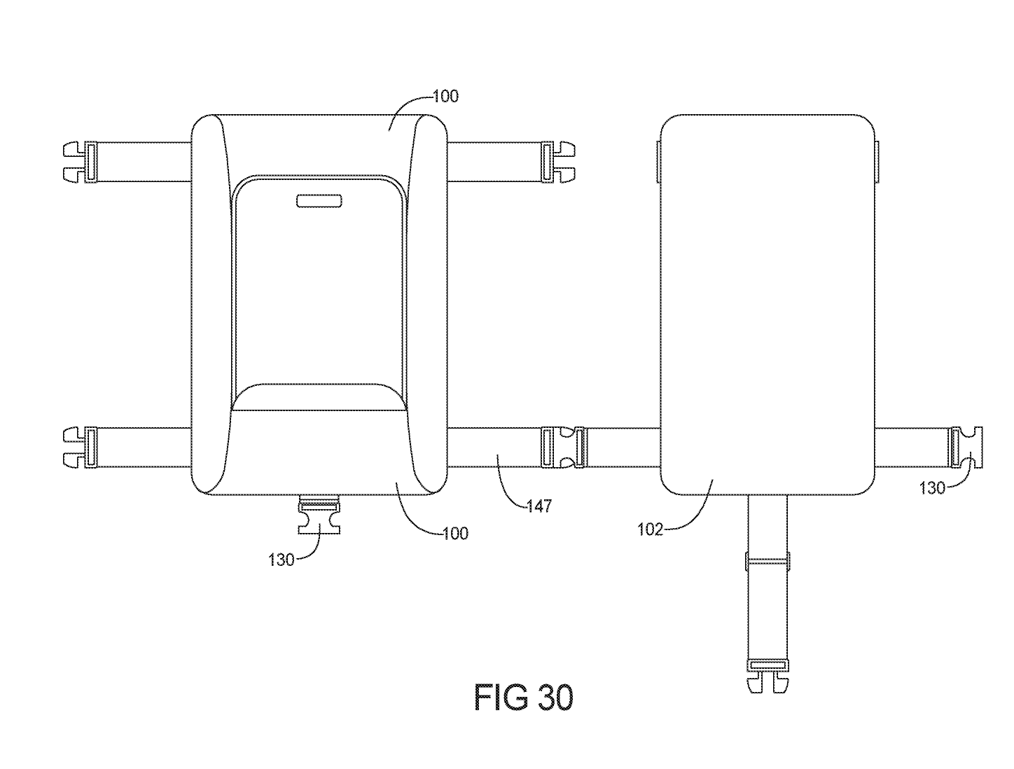

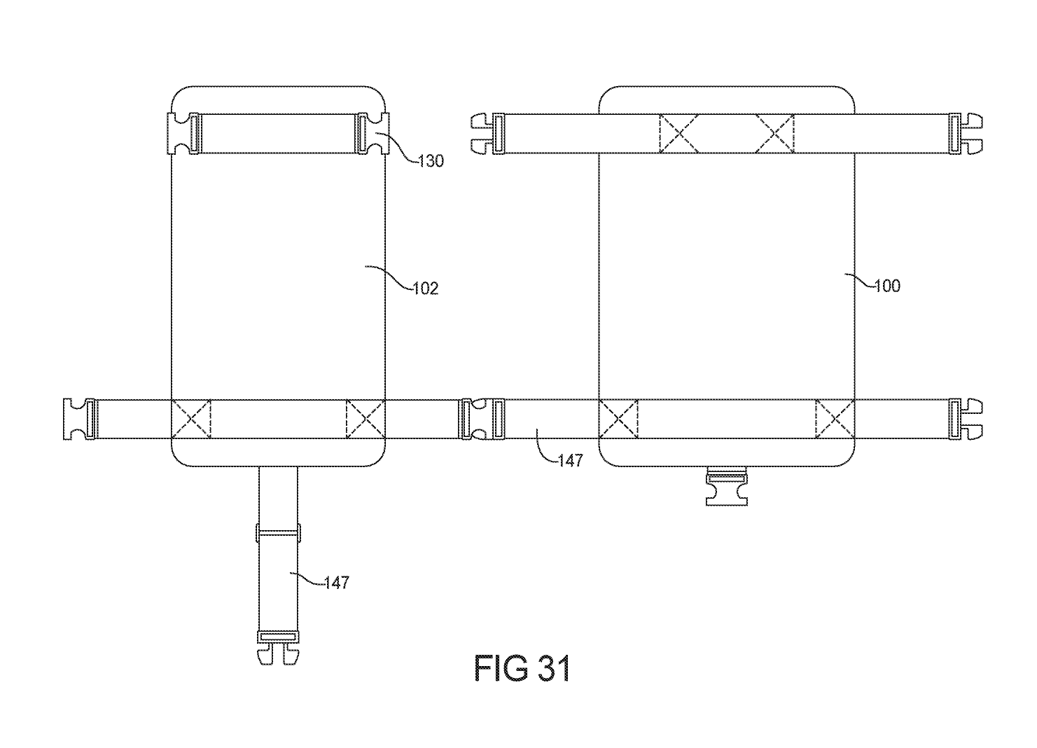

In the implementation shown in the FIGS. 8-32, the second fastening element 130 is comprised of three parts 132, 134, and 136 that enable the two body portions 110 and 112 to be selectively engaged to the lower front panel 109. The second fastening element 130 is adapted to selectively close the horizontal gap 126. In this implementation, the third part 132 is attached to the first body portion 110; the fourth part 134 is attached to the second body portion 112; and the fifth part 136 is attached to the front panel 109. When the third part 132 and a portion of the fifth part 136 and the fourth part 134 and a remainder of the fifth part 136 are fastened to partially or completely close the horizontal gap 126, the musical instrument 50 is more securely retained within the case 102 and the non-ridged component 103.

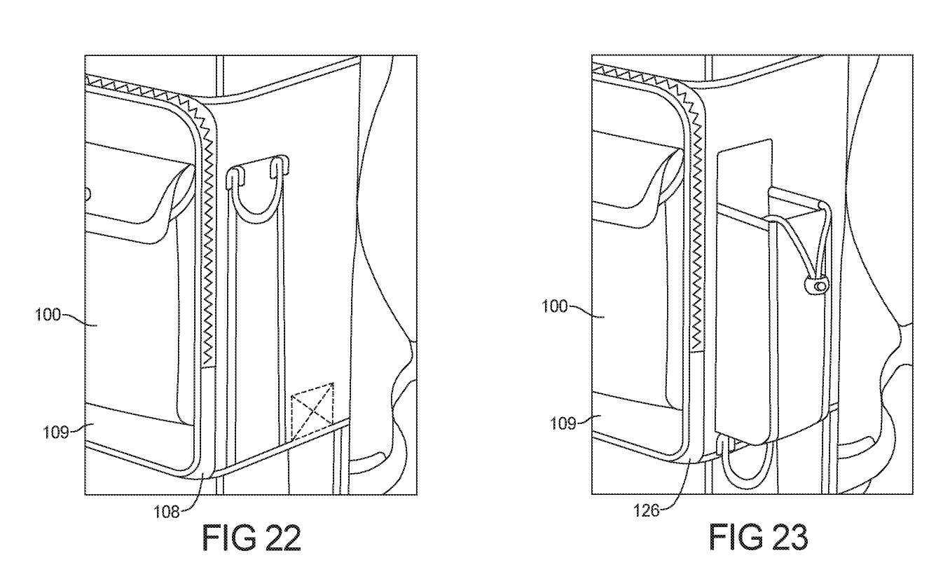

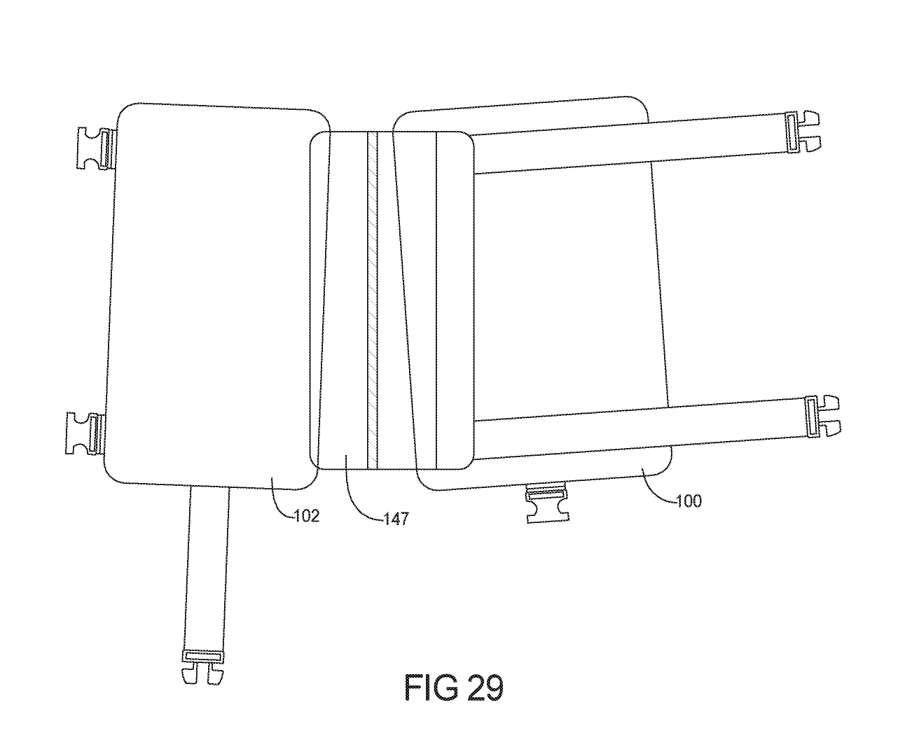

Additional features may also be added to the case 102. For example, a handle 140 may be attached to the case 102 to allow a user to carry the musical instrument carrying case and non-rigid support structure 100 by hand in a horizontal position. Optionally, as shown in FIGS. 22-23 and 26-29, the strap across the vertical gap can be passed through the handle of the ridged case. A pocket 142 for an internal structural rib or a music stand may also be attached to the side 108 of the case 102 to further maintain the case 102 in an inclined or upright position or to prevent the case 102 from sliding on slick surfaces. Optionally, this pocket 142 can be used to carry a folded music stand. The internal support may be made from rubber, wood, metal coated with rubber, or any other material that can assist the case 102 in resisting any sliding while in the inclined or upright position. The support structure may also be angled to cooperatively maintain the case 102 in a slightly angled, but upright, position with the non-rigid support structure 100. As shown in FIGS. 28 and 29, by incorporating an angled fabric panel or strap, cases shaped like a trapezoidal prism can be accommodated.

A front pocket 146 may also be included on the front panel 109 on the front side 104 of the case 102 for storing accessories for the musical instrument 50 or any other items, such as sheet music or guitar picks. This front pocket 146 may be secured by a fourth fastening element 141, such as a zipper to selectively close the pocket 144. Carrying straps 150 may be attached to the case 102 to allow users to transport the carrying case and non-rigid support structure 100 on their backs.

An exemplary pivotal attachment is shown as a stitch that is affixed to the non-rigid material of the carrying case 102, via adhesive, rivets, stitching, or other fastening means. The releasable strap 147 may be made from fabric, composites, plastics, or any other flexible material capable of supporting the case 102 in an upright or inclined position with a musical instrument 50 inside when carried. When the carrying case and non-rigid support structure 100 is being transported, the releasable strap 147 may be pivoted about the first end 148 to a first or carrying position where the releasable strap 147 is substantially parallel with the backside 105 of the case 102.

Alternatively, when the non-rigid carrying case 102 needs to be positioned in an upright or inclined position for access to the musical instrument 50 therein, the releasable strap 147 can be disconnected and pivoted to a second or supporting position. For this second position, the releasable strap 147 of the non-rigid support structure 100 may be pivoted about the first end 148 so that the second end 149 of the releasable strap 147 may be set at a second predetermined distance away from the case 102 (i.e. the “supporting position”), where the releasable strap 147 supports the lower portion of the case 102, or pocket 113, and maintains the back of the lower part of the case 102 taut below the point where the first end 148 of the releasable strap 147 is pivotally attached to the backside 105. When the lower part of the case 102 is taut, the pocket 113 (shown in FIG. 5) remains in an open position without the musical instrument 50 being disposed therein. In one implementation, the second end 149 of the releasable strap 147 adds stability to the carrying case and non-rigid support structure 100 when the non-rigid support structure 100 is engaged about the ridged case 102.

A further implementation of the non-rigid support structure 100 may also include a first member 146 and a second member 145 attached to the backside 105 of the case 102. In this implementation, the releasable strap 147 is disposed between first member 146 and second member 145, so that the first member 146 and the second member 145 can guide and horizontally retain the releasable strap 147. These additional members 146 and 145 can provide extra adjustability to the backside 105 of the case 102 and can further stabilize the carrying case and non-rigid support structure 100 when used in an upright position. The first member 146 and the second member 145 may be made from materials such as metal, composites, plastics, wood, or other rigid materials. The releasable strap 147, the first member 146, and the second member 145 may also each have a thickness such that each is co-planar with the others.

In another implementation, the non-rigid support structure 100 may have a strap 143 attached between the releasable strap 147 and the backside 105 of the case 102. The strap 143 may be made from nylon, rope, cloth, rubber, or any other pliable material that can limit the distance the releasable strap 147 can be pivoted to. Accordingly, the strap 143 may be used to limit the distance of the releasable strap 147 to the predetermined distance (d2) away from the case 102 that will support the non-rigid case 102 with or without the musical instrument 50 inside. The strap 143 may be flattened and folded upon itself when the releasable strap 147 is pivoted to the first or carrying position. In particular, when the releasable strap 147 is pivoted to the first or carrying position, the strap 143 may be folded between the backside 105 of the case 102 and the releasable strap 147.

In one embodiment, the releasable strap 147 has a first thickness and each of the first and second members 146 and 145 have a second thickness that is greater than the first thickness. In this embodiment, when the releasable strap 147 is pivoted to the first or carrying position, the strap 143 folds upon itself to have a third thickness such that the outer surface of the releasable strap 147 is substantially co-planar (e.g. within 0 to ⅛ in.) of the outer surface of the first and second members 146 and 145. This co-planar embodiment enables the non-rigid support structure 100 to be comfortably pressed against a user's back when the carrying case and non-rigid support structure 100 is carried by the user.

In a further implementation, the non-rigid support structure 100 may also have a third fastening element 141 attached to the backside 105 of the case 102 and the releasable strap 147. This third fastening element 141 may be adapted to selectively attach the releasable strap 147 to the backside 105 of the case 102. The third fastening element 141 retains the releasable strap 147 against the backside 105 of the case 102 when the carrying case and non-rigid support structure 100 is being transported or stored. The third fastening element 141 may be a hook and loop fastener, snap fastener, or any other fastener that can be selectively engaged and disengaged.

The carrying case and non-rigid support structure 100 with the vertical gap 114 and the horizontal gap 126 opened and the first body portion 110 and the second body portion 112 folded down to expose the musical instrument 50 within the non-rigid case 102, consistent with the present disclosure. With the body portions 110 and 112 folded down, the user can easily remove the musical instrument 50 from the pocket 113 of the case 102. When the musical instrument 50 is removed, the pocket 113 does not collapse with the non-rigid support structure 100 in the supporting position, as described herein. This allows the user to put the musical instrument 50 back into the pocket 113 of the non-rigid case 102 while lying the non-rigid case 102 down or manually holding the non-rigid case 102 upright. Thus, the non-rigid case will collapse the pocket and the musical instrument and ridged case cannot be easily replaced into the case.

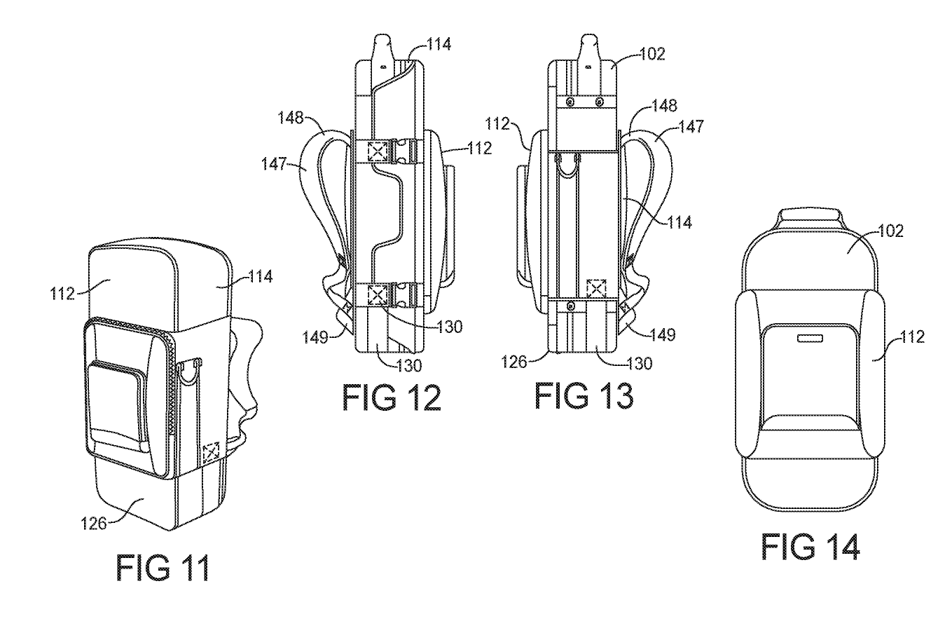

FIGS. 11-20 depict the non-rigid support structure 100 of a second embodiment of a carrying case and non-rigid support structure consistent with the present disclosure. The ridged case 102 and other components included on the front side 104 of the case 102 may be the same or consistent with those described for the carrying case and non-rigid support structure 100 of the first embodiment.

A user can use the carrying case and non-rigid support structure 100 to store their musical instrument 50 inside when transporting the musical instrument 50 from one performance to the next. Once the user arrives at the destination, the user can then pivot the releasable strap 147 to the second position to open the non-rigid case. The removable non-rigid support structure 100 with the case 102 reduces the number of items a music player needs to transport when traveling with their musical instrument. Additionally, the non-rigid case material reduces the weight and cost as compared to other rigid instrument cases with non-rigid support structures. When the user desires to either display their instrument or play their instrument, the vertical gap 114 and horizontal gap 126 can be opened. The first body portion 110 and the second body portion 112 can then be folded down to expose or display the musical instrument 50.

The user can then remove the musical instrument 50 from the pocket 113 and the pocket 113 will collapse. When the user is done playing, the musical instrument 50 can be returned to the pocket 113 to effectively organize the musical instrument 50 and associated equipment while the musical instrument 50 is not in use. When the user is ready to transport the musical instrument 50 to a new location, the user can fold up the first body portion 110 and the second body portion 112, close the vertical gap 114 and the horizontal gap 126, pivot the releasable strap 147 to the first position, and carry the case 102 holding the musical instrument 50 either by the handle 140 or the carrying straps 150.

In one implementation, padding (such as foam or stiff fabric) may be disposed in the bottom, internal corners of the pocket 113 to provide further support for the musical instrument 50 when the carrying case and non-rigid support structure 100 is positioned in a reclined or upright position as described herein. In addition, the case 102 may include other structural materials such as boning elements in the fabric used to form the case 102.

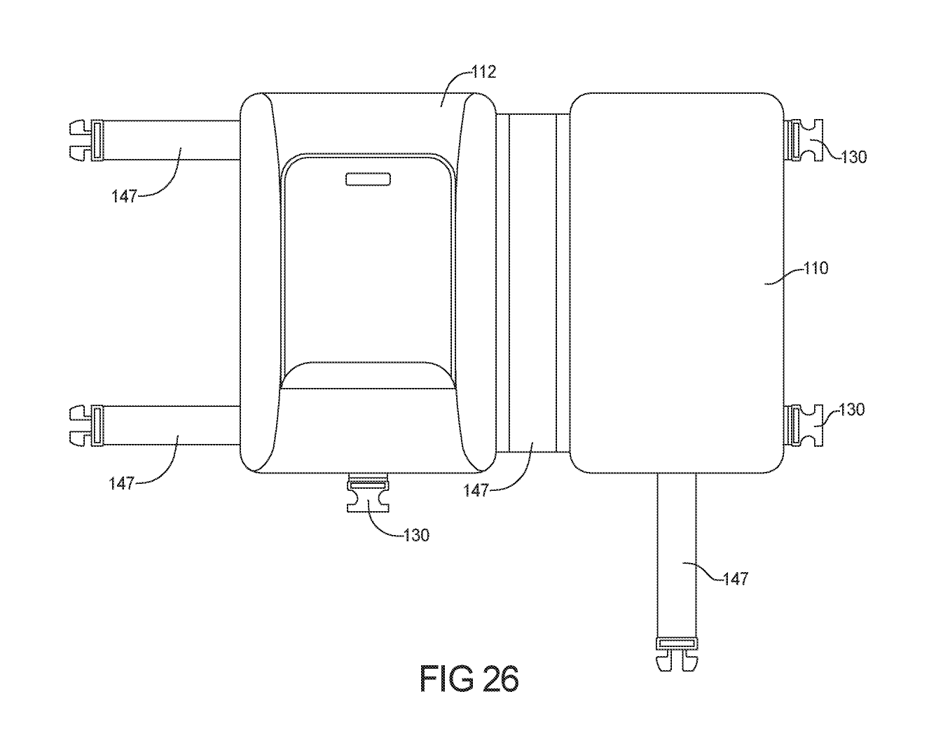

Shown in FIGS. 26-31, a musical instrument carrying structure comprising is shown having a ridged case 102 having a first and second opposed sides, a bottom side, a top side, a back side, and a front side that collectively define a first internal cavity configured to accommodate and enclose a musical instrument. The non-rigid support structure, defining a first body portion in contact with the back side of the ridged case and second body portion in contact with the front side of the ridged case, the second body portion defining a pocket, the first and second body portion defining a vertical gap disposed adjacent the first and second opposed sides and a horizontal gap disposed adjacent the bottom side. A first support strap disposed between the first and second body portions and adjacent the bottom side. Second and third support straps disposed between the first and second body portions and adjacent the first and second opposed sides a plurality of straps between the first and second body portions. The opposed sides define a concave surface and the second and third support straps are in contact with the concave surface. Optionally, the rigid support case can have a handle and where at least one of the straps is disposed through the handle.

While various embodiments of the present disclosure have been described, it will be apparent to those of skill in the art that many more embodiments and implementations are possible that are within the scope of this disclosure. Accordingly, the present disclosure is not to be restricted except in light of the attached claims and their equivalents.

Example embodiments are provided so that this disclosure will be thorough, and will fully convey the scope to those who are skilled in the art. Numerous specific details are set forth such as examples of specific components, devices, and methods, to provide a thorough under non-rigid support structuring of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A musical instrument carrying case structure comprising:
a ridged case having a concave side, a bottom side, a top side, a backside, and a front side that collectively define a first internal cavity configured to accommodate and enclose a musical instrument;
a non-rigid support structure, defining a second internal cavity having a first body portion positioned against the front side of the ridged case and a second body portion positioned against the backside of the ridged case, the first and second body portions defining a vertical gap and a horizontal and having a pair of side straps selectively attachable there between, at least one side strap being positioned within a depression formed by the concave side.

2. A musical instrument carrying case and non-rigid support structure according to claim 1, wherein the non-ridged component is formed of fabric.

3. A musical instrument carrying case and non-rigid support structure according to claim 1, wherein one of the vertical gap and horizontal gap are traversed by at least a portion of the ridged case.

4. A musical instrument carrying case and non-rigid support structure according to claim 1, wherein a first end of one of the side straps is selectively coupled to a fastener disposed between the first and second body portions.

5. A musical instrument carrying case and non-rigid support structure according to claim 4, wherein the pair of side straps, are substantially parallel.

6. A musical instrument carrying case and non-rigid support structure according to claim 4, further comprising a pair of shoulder straps coupled to the first body portion.

7. A musical instrument carrying case and non-rigid support structure according to claim 1, further comprising a central lower fixed support strap fixably coupled between the first and second body portions.

8. A musical instrument carrying case and non-rigid support structure according to claim 4, further comprising a third fastening element attached to the backside of the rigid case configured to selectively attach the releasable strap to the backside of the case, wherein the third fastening element cooperatively retains the releasable strap in a coplanar position with the first and second members.

9. A musical instrument carrying case structure comprising:
a ridged case having a concave side, a bottom side, a top side, a backside, and a front side that collectively define a first internal cavity configured to accommodate and enclose a musical instrument;
a non-rigid support structure, defining a second internal cavity having a first body portion in contact with the backside of the ridged case and second body portions in contact with the backside of the ridged case, the second body portion defining a pocket, the first and second body portion defining a vertical gap and a horizontal gap there between and having a plurality of straps selectively attachable between the first and second body portions at least one strap being disposed within a depression formed by the concave side of the ridged case.

10. The musical instrument carrying case of claim 9, wherein the plurality of straps have selectively adjustable lengths.

11. The musical instrument carrying case of claim 9, wherein the plurality of straps comprise hook and loop fastener parts.

12. A musical instrument carrying case and non-rigid support structure according to claim 9, wherein the first end of the releasable strap is disposed between first and second members.

13. A musical instrument carrying case and non-rigid support structure according to claim 9, further comprising a pair of adjustable shoulder straps coupled to the first body portion.

14. A musical instrument carrying case structure comprising:
a ridged case having a first and second opposed sides, a bottom side, a top side, a back side, and a front side that collectively define a first internal cavity configured to accommodate and enclose a musical instrument;
a non-rigid support structure, defining a first body portion in contact with the back side of the ridged case and second body portion in contact with the front side of the ridged case, the second body portion defining a pocket, the first and second body portion defining a vertical gap disposed adjacent the first and second opposed sides and a horizontal gap disposed adjacent the bottom side;
a first support strap disposed between the first and second body portions and adjacent the bottom side;
second and third support straps disposed between the first and second body portions and adjacent the first and second opposed sides a plurality of straps between the first and second body portions.

15. The musical instrument carrying case of claim 14, opposed sides define a concave surface and the second and third support straps are in contact with the concave surface.

16. The musical instrument carrying case of claim 15, wherein rigid case comprises a handle and wherein at least one of the straps is disposed through the handle.

17. The musical instrument carrying case of claim 14, wherein the straps are selectively attachable.

18. The musical instrument carrying case of claim 14, wherein at least one strap is trapezoidal in shape.
